(19) United States
(12) Patent Application Publication
(10) Pub. No.: US 2010/0063861 A1
(43) Pub. Date: Mar. 11, 2010

(54) PROMOTIONAL ASSOCIATION SYSTEM AND METHOD

(76) Inventors: Richard Jude Dominguez, Temecula, CA (US); Michael Anthony Grimsley, Menifee, CA (US); Luc Doan, Murrieta, CA (US)

Correspondence Address: HOLLAND & KNIGHT LLP, 10 ST. JAMES AVENUE, BOSTON, MA, 02116-3889, US

(21) Appl. No.: 12/205,602

(22) Filed: Sep. 5, 2008

(51) Int. Cl. G06Q 10/00; G06F 17/00

(52) U.S. Cl. 705/10; 235/375

(57) ABSTRACT

A method, system, and computer program product for defining an identity of a patron. An account associated with the patron is determined, and either the account or the identity is associated with a promotion. The association defines promotional association data.

### RELATED APPLICATIONS

This disclosure claims the benefit of the following application(s), each of which is herein incorporated by reference: U.S. Utility patent application Ser. No. 12/123,100, which is entitled SYSTEM AND METHOD FOR ESTABLISHING MEMBERSHIP and was filed on 19 May 2008.

### TECHNICAL FIELD

This disclosure relates to membership systems and, more particularly, to associating a member to a promotion.

### BACKGROUND

Many establishments maintain customer loyalty programs. A patron becomes a member of the program typically by providing his or her name and address to the establishment. A membership card is given to the patron and subsequently scanned or swiped upon each visit to or transaction within the establishment. Details of the patron's membership (e.g., identity, member number) are stored by a membership system. The patron benefits from the membership by receiving discounts and promotional offers. The establishment benefits from the membership by the ability to track valuable market data. This may include information such as: how much money an individual has spent at the establishment, what products or services are more popular among customers from various regions, how one product correlates to another (e.g., whether people who buy product A tend to also buy product B), whether promotional mailings are successful, and many others.

In some cases, a patron receives a promotional offer such as an invitation to attend a special event or a certificate redeemable for something of value. It may be desirable for the establishment to know which patrons responded to such offers. Unfortunately, there has not been a convenient and time-efficient manner for capturing such information.

### SUMMARY OF THE DISCLOSURE

In a first implementation, a method includes defining an identity of a patron. An associated account is determined, and the account or the identity is associated with a promotion. The association defines promotional association data.

One or more of the following features may be included. Defining the identity may include processing encoded data. Processing encoded data may include reading a magnetic strip, a bar code, an RFID tag, an optical code, an image, text, a fingerprint, a retinal image, or a facial likeness. The encoded data may be contained on a driver's license, a membership card, a passport, a proximity card, a social security card, a credit card, a debit card, or any other government-issued or privately-issued form of identification.

The identity may be defined on a handheld device or a stationary device.

The identity, the account, or the promotional association data may be provided to a membership system or a promotions system. The identity, the account, or the promotional association data may be wirelessly transmitted.

In another implementation, a system is configured to perform operations including defining an identity of a patron. An associated account is determined, and the account or the identity is associated with a promotion. The association defines promotional association data.

One or more of the following features may be included. Defining the identity may include processing encoded data. Processing encoded data may include reading a magnetic strip, a bar code, an RFID tag, an optical code, an image, text, a fingerprint, a retinal image, or a facial likeness. The encoded data may be contained on a driver's license, a membership card, a passport, a proximity card, a social security card, a credit card, a debit card, or any other government-issued or privately-issued form of identification.

The identity may be defined on a handheld device or a stationary device.

The identity, the account, or the promotional association data may be provided to a membership system or a promotions system. The identity, the account, or the promotional association data may be wirelessly transmitted.

In another implementation, a computer program product resides on a computer readable medium having a plurality of instructions stored on it. When executed by a processor, the instructions cause the processor to perform operations including defining an identity of a patron. An associated account is determined, and the account or the identity is associated with a promotion. The association defines promotional association data.

One or more of the following features may be included. Defining the identity may include processing encoded data. Processing encoded data may include reading a magnetic strip, a bar code, an RFID tag, an optical code, an image, text, a fingerprint, a retinal image, or a facial likeness. The encoded data may be contained on a driver's license, a membership card, a passport, a proximity card, a social security card, a credit card, a debit card, or any other government-issued or privately-issued form of identification.

The identity may be defined on a handheld device or a stationary device.

The identity, the account, or the promotional association data may be provided to a membership system or a promotions system. The identity, the account, or the promotional association data may be wirelessly transmitted.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a diagrammatic view of a promotional association system coupled to a distributed computing network; and

FIG. 2 is a flowchart of the process executed by the promotional association system of FIG. 1.

Like reference symbols in the various drawings indicate like elements.

### DETAILED DESCRIPTION OF THE DISCLOSURE

### System Overview:

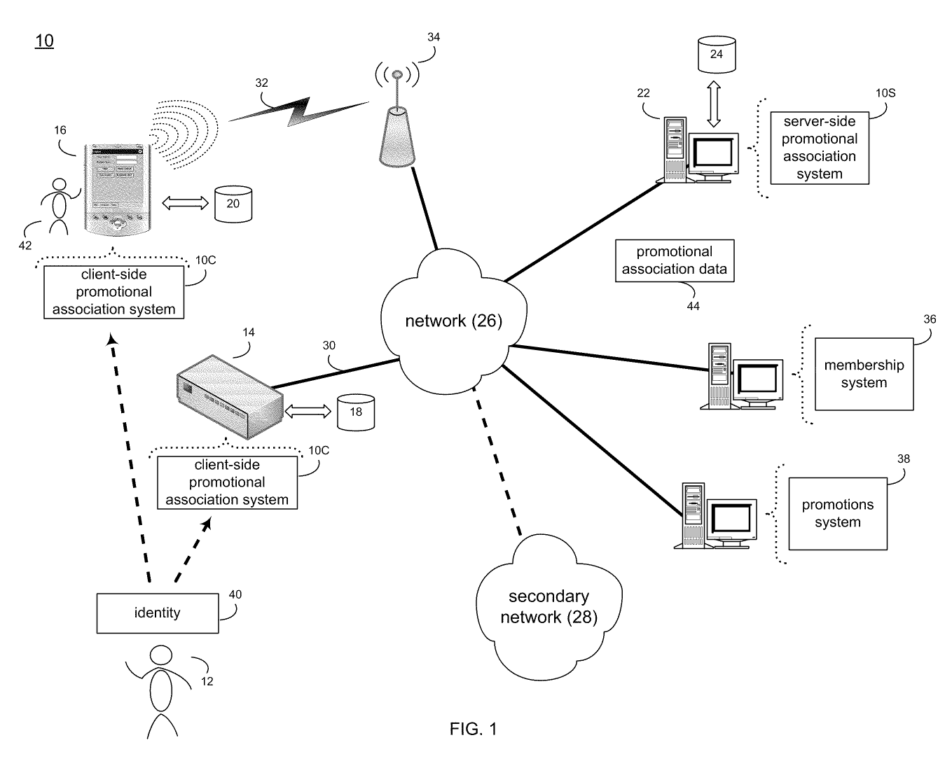

Referring to FIG. 1, there is shown promotional association system 10. As will be discussed below in greater detail, when a patron (e.g. patron 12) at an establishment (e.g., a casino) attends a promotional event or participates in a promotional offer, it may be desirable to associate the patron with the promotion (i.e., make a record of the fact that the patron participated in or responded to the promotion). As will be discussed below in greater detail, this association may be effectuated by promotional association system 10.

A promotion may be an event attended by a group of patrons, or may be an offer responded to, accepted, or participated in by one or more patrons, or may involve any grouping of patrons in which the establishment has an interest. What constitutes a promotion may depend upon the needs and decisions of marketing and/or business concerns. For example, a group of patrons (including patron 12) may each arrive on the same day for a special raffle or drawing for which they received a promotional mailing. As another example, a group of patrons (including patron 12) may each arrive on different days or at different times to redeem a special coupon or voucher. Other examples that may constitute a promotional group may include but are not limited to: frequent flyer members on a particular flight or patrons who arrived on a particular bus or train. It may be desirable to associate each of these patrons as a member of a promotion. Accordingly, promotional association system 10 may be utilized to effectuate this association.

In such a case, the patron may present an account/membership card. The membership card may often include encoded data in some form from which a device may retrieve the identification data.

The account/membership in question may be one of, for example, a rewards account, a customer loyalty program account, a credit account, a debit account, or a service account (e.g., at an auto shop or utility company). Examples of customer loyalty programs may include membership accounts or rewards accounts, for example: a frequent flyer account, a casino player's club account, a hotel rewards club account, or a grocery store ‘valued customer’ account.

All or a portion of the encoded data included within the above-described account/membership card may be processed on a stationary scanner/reader (e.g., stationary device 14) or on a handheld device (e.g., handheld device 16) and provided to one or more systems that may monitor/record the participation of patron 12 in various promotional events. Examples of stationary device 14 may include but are not limited to a kiosk, an overhead or frame-mounted reader/scanner, a point-of-sale-type card reader, and a pedestal-mounted reader/scanner. Examples of handheld device 16 may include but are not limited to a personal digital assistant, a laptop computer, a notebook computer, and a specialized device.

Promotional association system 10 may include a client-side portion (e.g., client-side promotional association system 10C) and a server-side portion (e.g., server-side promotional association system 10S) that may work cooperatively to effectuate the functionality of promotional association system 10.

Stationary device 14 may include various instruction sets and subroutines (e.g., client-side promotional association system 10C), which may be stored on storage device 18 coupled to/included within stationary device 14 and may be executed by one or more processors (not shown) and one or more memory architectures (not shown) incorporated into stationary device 14.

Examples of storage device 18 may include but are not limited to: a hard disk drive; a random access memory (RAM); a read-only memory (ROM), a compact flash (CF) storage device, a secure digital (SD) storage device, and a memory stick storage device. Stationary device 14 may run an operating system, examples of which may include but are not limited to: Microsoft Windows™, Microsoft Windows CE™, Redhat Linux™, PalmOS™, Apple Mac OS X™, or a custom operating system.

Handheld device 16 may include various instruction sets and subroutines (e.g., client-side promotional association system 10C), which may be stored on storage device 20 coupled to/included within handheld device 16 and may be executed by one or more processors (not shown) and one or more memory architectures (not shown) incorporated into handheld device 16.

Examples of storage device 20 may include but are not limited to: a hard disk drive; a random access memory (RAM); a read-only memory (ROM), a compact flash (CF) storage device, a secure digital (SD) storage device, and a memory stick storage device. Handheld device 16 may run an operating system, examples of which may include but are not limited to: Microsoft Windows™, Microsoft Windows CE™, Redhat Linux™, PalmOS™, Apple Mac OS X™, or a custom operating system.

Server-side promotional association system 10S may reside on and may be executed by server computer 22, which may be coupled to network 26 (e.g., the Internet or a local area network). Examples of server computer 22 may include, but are not limited to: a personal computer, a server computer, a series of server computers, a mini computer, and a mainframe computer. Server computer 22 may be a single server or a series of servers running a network operating system, examples of which may include but are not limited to: Microsoft Windows 2003 Server™; Novell Netware™; or Redhat Linux™, for example.

The instruction sets and subroutines of server-side promotional association system 10S, which may be stored on storage device 24 coupled to/included within server computer 22, may be executed by one or more processors (not shown) and one or more memory architectures (not shown) incorporated into server computer 22. Examples of storage device 24 may include but are not limited to: a hard disk drive; a tape drive; an optical drive; a RAID array; a random access memory (RAM); and a read-only memory (ROM).

Stationary device 14 may be coupled to distributed computing network 26 (e.g., the Internet or a local area network). Handheld device 16 may also be coupled to distributed computing network 26. Server computer 22 may be connected to network 26 and may execute a server application, examples of which may include but are not limited to: Microsoft IIS™, Novell Webserver™, or Apache Webserver™, that allows for access to server computer 22 via network 26. Network 26 may be connected to one or more secondary networks (e.g., network 28), examples of which may include but are not limited to: a local area network; a wide area network; or an intranet, for example.

Stationary device 14 may be directly or indirectly coupled to network 26, or network 28, or server computer 22. For example, stationary device 14 is shown directly coupled to network 26 via wired communication channel 30 which may be effectuated using e.g., an Ethernet port (IEEE 802.3), a Token Ring port (IEEE 802.5), and/or a LAN port that is capable of coupling stationary device 14 to network 26. Stationary device 14 may additionally/alternatively be coupled to network 26 via a wireless communication channel (not shown) established between handheld device 16 and wireless access point 34, which is shown directly coupled to network 26. Wireless access point 34 may be, for example, an IEEE 802.11a, 802.11b, 802.11g, Wi-Fi, IEEE 802.15, Bluetooth, and/or infrared device that is capable of establishing a wireless communication channel (not shown) between stationary device 14 and wireless access point 34. Additionally, stationary device 14 may alternatively be coupled directly to server computer 22 via a wired communication channel (not shown) effectuated using a Universal Serial Bus (i.e., USB) port, an IEEE 1394 port, an Ethernet port, a parallel port, and/or a serial port that is capable of coupling stationary device 14 to server computer 22.

Handheld device 16 may be directly or indirectly coupled to network 26, or network 28, or server computer 22. For example, handheld device 16 is shown wirelessly coupled to network 26 via wireless communication channel 32 established between handheld device 16 and wireless access point 34, which is shown directly coupled to network 26. Wireless access point 34 may be, for example, an IEEE 802.11a, 802.11b, 802.11g, Wi-Fi, IEEE 802.15, Bluetooth, and/or infrared device that is capable of establishing wireless communication channel 32 between handheld device 16 and wireless access point 34. Handheld device 16 may additionally/alternatively be coupled to network 26 via a wired communication channel (not shown) effectuated using a Universal Serial Bus (i.e., USB) port, an IEEE 1394 port, an Ethernet port, a parallel port, and/or a serial port that is capable of coupling handheld device 16 to network 26 or server computer 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless interface.

Promotional association system 10 (e.g., client-side promotional association system 10C and/or server-side promotional association system 10S) may work cooperatively with an existing membership system (e.g., membership system 36) that maintains the accounts of patrons (e.g., a membership database) and/or an existing promotions system (e.g., promotions system 38) that maintains marketing and promotional information. Accordingly, server-side promotional association system 10S may be executed on the same computer platform as membership system 36 and/or promotions system 38. For example, server-side promotional association system 10S may be implemented as an add-on, plug-in, or API (Application Programming Interface) in conjunction with membership system 36 and/or promotions system 38.

### System Operation:

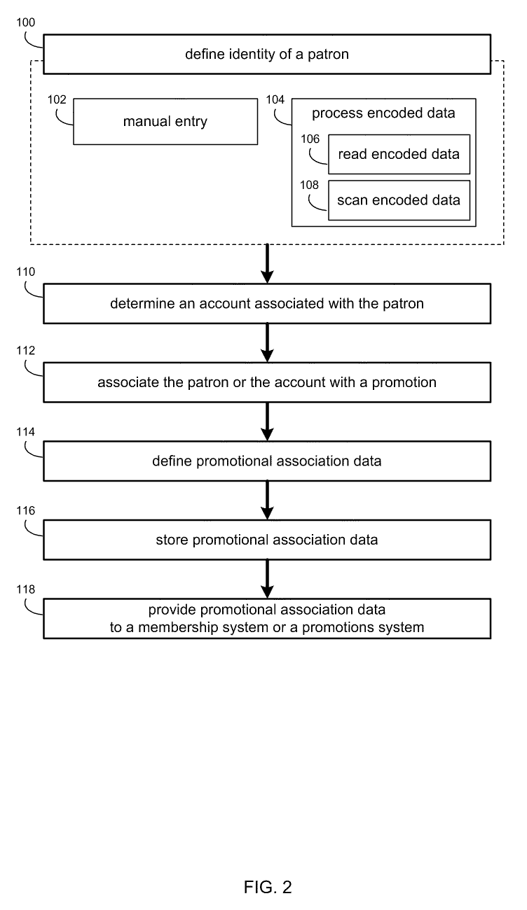

Referring also to FIG. 2, assume that patron 12 attends a promotional event or participates in a promotional offer at an establishment. Further assume that he or she may present some form of identification. Accordingly, promotional association system 10 may be used to associate the attendance/participation of patron 12 in the promotion.

Identity 40 of patron 12 may be defined 100 (at least in part) by employee 42, who may manually enter 102 identity 40 into stationary device 14 or handheld device 16. Identity 40 may be defined 100 by e.g., employee 42 asking patron 12 for his/her identity and/or asking patron 12 to provide a form of identification. The requisite information may then be manually entered 102 into stationary device 14 or handheld device 16 through, e.g., a keypad or touch screen (not shown).

In another embodiment, identity 40 may be defined 100 by processing 104 data that is encoded within some form of identification, examples of which may include but are not limited to: a driver's license, a membership card (such as a customer loyalty card), a credit card, a proximity card, a passport, or any other government-issued or privately-issued identification. Alternatively, some form of biological identification (e.g., fingerprints, retinal scans, or facial recognition) may be utilized. Data may be encoded using a variety of methodologies, examples of which may include but are not limited to: a magnetic strip, a barcode, an optical code, an RFID tag, an image, or text.

The processing of the encoded data may include reading 106 a magnetic strip, a barcode, an RFID tag, or an optical code; or may include scanning 108 an image, text, fingerprint, retina, or facial likeness. Accordingly, stationary device 14 and/or handheld device 16 may include a magnetic strip reader (not shown), a barcode reader (not shown), an RFID reader (not shown), an optical scanner (not shown), or a biometric scanner/reader (not shown).

For example, a driver's license or a credit card of patron 12 may have data encoded within a magnetic strip. A magnetic strip reader (not shown) included within stationary device 14 or handheld device 16 may read 106 the magnetic strip when the driver's license of patron 12 is swiped through the strip reader. Depending on the manner in which the magnetic strip is configured, the magnetic strip may directly contain the identity of patron 12 or may contain reference data from which the identity of patron 12 may further be determined. For example, a record number or an account number may be defined within the magnetic strip, which may be used to determine the identity of patron 12 via a lookup operation performed on a database (e.g., a motor vehicle database or a bank credit account database).

If the form of identification does not contain a magnetic strip but does include e.g., the name, address and/or photograph of patron 12, stationary device 14 or handheld device 16 may e.g., scan 108 the driver's license (or other form of identification) with an included scanner (not shown) and may further process the scan by e.g., storing the scan as an image file, conducting optical character recognition to extract text-based data, and storing the text-based data. Additionally/alternatively, face recognition software (not shown) may be utilized to process the photograph included within the driver's license (or other form of identification) to identify patron 12 from the photograph.

As discussed above, identity 40 (as defined 100 on stationary device 14 or handheld device 16) may include the identity of patron 12 either directly (e.g., by name, address, social security number, etc.) or indirectly (e.g., by driver's license number, account number(s), photographic image, etc.). Additionally, other pieces of information may be included in identity 40, examples of which may include but are not limited to: identity of the user of stationary device 14 or handheld device 16 (e.g., employee 42), identity of stationary device 14 or handheld device 16, and date/time the information was entered into stationary device 14 or handheld device 16.

As discussed above, promotional association system 10 may include a client-side portion (e.g., client-side promotional association system 10C) and a server-side portion (e.g., server-side promotional association system 10S) that may work cooperatively to effectuate the functionality of promotional association system 10. Further and as discussed above, client-side promotional association system 10C may be executed on e.g., stationary device 14 and/or handheld device 16 and server-side promotional association system 10S may be executed on e.g., server computer 22.

In such a client-side/server-side implementation, at least a portion of identity 40 may be provided from client-side promotional association system 10C to server-side promotional association system 10S through any of a number of different interfaces and mechanisms. For example, either or both of stationary device 14 and handheld device 16 (i.e., a device that executes client-side promotional association system 10C) may be coupled to server computer 22 (i.e., the computer that executes server-side promotional association system 10S) via a direct cable interface, via a direct coupling to network 26, or via a wireless interface (e.g., wireless communication channel 30) as discussed above. Further, there may be a plurality of stationary devices and/or handheld devices that execute client-side promotional association system 10C and that are each coupled to server computer 22.

At least a portion of identity 40 may be stored by promotional association system 10. Specifically, at least a portion of identity 40 may be stored on a storage device (e.g., storage device 18 or storage device 20) coupled to a device that executes client-side promotional association system 10C (e.g., stationary device 14 or handheld device 16) and/or on a storage device (e.g., storage device 24) coupled to a computer that executes server-side promotional association system 10S (e.g., server computer 22).

At least a portion of identity 40 may be processed by promotional association system 10 (i.e., client-side promotional association system 10C and/or server-side promotional association system 10S) to determine 110 an account associated with patron 12. Determining 110 an account associated with patron 12 may include determining an account number or other account identifier, record number, or additional identifying information. To determine 110 the account, promotional association system 10 may perform a query against a membership database (not shown) maintained by a membership system (e.g., membership system 36) or may compare all or a portion of identity 40 to a list of patrons having accounts. A successful query or a match within the list may result in an account number or other account identifier, record number, or additional account identifying information.

For example, promotional association system 10 may submit a query across network 26 to membership system 36 in order to effectuate determining 110 an account associated with patron 12. Alternatively, server-side promotional association system 10S may be implemented as a plug-in, add-on, or API coupled to membership system 36, as discussed above, and therefore a query may be performed as a local operation. In another embodiment, promotional association system 10 may download a list of patrons having accounts from membership system 36 and compare identity 40 directly to the downloaded list. Further, promotional association system 10 may be pre-configured with a list of patrons having accounts, which may be stored e.g., on one or more of storage devices 18, 20, or 24.

Promotional association system 10 (i.e., client-side promotional association system 10C and/or server-side promotional association system 10S) may associate 112 the account with a promotion and/or associate 112 patron 12 with a promotion. Promotional association system 10 may retrieve information about a promotion from a promotions system (e.g., promotions system 38), which may maintain a promotions database (not shown). Alternatively, promotional association system 10 may be manually configured with promotional information by e.g., employee 42. Promotional information may include but is not limited to: promotion identification number, promotion name, date/time information, or location information.

Additionally, associating 112 the account (or patron 12) with a promotion may further define 114 promotional association data 44. Promotional association data 44 may include but is not limited to: an account identifier, record number, all or a portion of identity 40, event identifiers (e.g., promotion identification number, promotion name, etc.), company name(s), cost/financial data, location, and date/time information. Promotional association system 10 may store 116 promotional association data 44 (e.g., on any of storage devices 18, 20, 24) for subsequent retrieval or future processing. Additionally, promotional association system 10 may provide 118 all (or a portion of) promotional association data 44 to a membership system (e.g., membership system 36) or a promotions system (e.g., promotions system 38), immediately or at some future time.

It will be understood that the processes and functions described herein may be executed anywhere and on any device or system, consolidated or distributed, capable of performing the functions recited. Specifically, either of client-side promotional association system 10C or server-side promotional association system 10S, or their constituent parts and equipment, may be incorporated together into fewer systems or devices, or incorporated into other systems and devices (e.g., membership system 36 or promotions system 38), or may be separated and distributed across multiple systems and devices beyond that shown.

A number of implementations have been described. Nevertheless, it will be understood that various modifications may be made. Accordingly, other implementations are within the scope of the following claims.

What is claimed is:

1. A method comprising:
defining an identity of a patron;
determining an account associated with the identity; and
associating one or more of the account and the identity with a promotion to define promotional association data.

2. The method of claim 1 wherein defining an identity of a patron includes processing encoded data.

3. The method of claim 2 wherein processing encoded data includes reading one or more of a magnetic strip, a bar code, an RFID tag, an optical code, an image scan, a text scan, a fingerprint scan, a retinal scan, and a facial likeness.

4. The method of claim 2 wherein processing encoded data includes processing encoded data contained on one or more of a driver's license, a membership card, a passport, a proximity card, a social security card, a credit card, a debit card, a government-issued identification, and a privately-issued identification.

5. The method of claim 1 wherein defining an identity of a patron includes defining an identity of a patron on a handheld device.

6. The method of claim 1 further comprising providing one or more of the identity, the account, and the promotional association data to one or more of a membership system and a promotions system.

7. The method of claim 1 further comprising wirelessly transmitting one or more of the identity, the account, and the promotional association data.

8. A system configured to perform operations comprising:
defining an identity of a patron;
determining an account associated with the identity; and
associating one or more of the account and the identity with a promotion to define promotional association data.

9. The system of claim 8 wherein defining an identity of a patron includes processing encoded data.

10. The system of claim 9 wherein processing encoded data includes reading one or more of a magnetic strip, a bar code, an RFID tag, an optical code, an image scan, a text scan, a fingerprint scan, a retinal scan, and a facial likeness.

11. The system of claim 9 wherein processing encoded data includes processing encoded data contained on one or more of a driver's license, a membership card, a passport, a proximity card, a social security card, a credit card, a debit card, a government-issued identification, and a privately-issued identification.

12. The system of claim 8 wherein defining an identity of a patron includes defining an identity of a patron on a handheld device.

13. The system of claim 8 further configured to perform operations comprising providing one or more of the identity, the account, and the promotional association data to one or more of a membership system and a promotions system.

14. The system of claim 8 further configured to perform operations comprising wirelessly transmitting one or more of the identity, the account, and the promotional association data.

15. A computer program product residing on a computer readable medium having a plurality of instructions stored thereon, which, when executed by one or more processors, cause the one or more processors to perform operations comprising:
defining an identity of a patron;
determining an account associated with the identity; and
associating one or more of the account and the identity with a promotion to define promotional association data.

16. The computer program product of claim 15 wherein the instructions for defining an identity of a patron include instructions for processing encoded data.

17. The computer program product of claim 16 wherein the instructions for processing encoded data include instructions for reading one or more of a magnetic strip, a bar code, an RFID tag, an optical code, an image scan, a text scan, a fingerprint scan, a retinal scan, and a facial likeness.

18. The computer program product of claim 16 wherein the instructions for processing encoded data include instructions for processing encoded data contained on one or more of a driver's license, a membership card, a passport, a proximity card, a social security card, a credit card, a debit card, a government-issued identification, and a privately-issued identification.

19. The computer program product of claim 15 wherein the instructions for defining an identity of a patron include instructions for defining an identity of a patron on a handheld device.

20. The computer program product of claim 15 further comprising instructions for providing one or more of the identity, the account, and the promotional association data to one or more of a membership system and a promotions system.

21. The computer program product of claim 15 further comprising instructions for wirelessly transmitting one or more of the identity, the account, and the promotional association data.
